(19) United States
(12) Patent Application Publication
(10) Pub. No.: US 2019/0009191 A1
(43) Pub. Date: Jan. 10, 2019

(54) Application of Zea Mays Cob as a Heavy Metal Ion Exchange Filter for Water purification

(71) Applicant: Simar Kohli, Syosset, NY (US)

(72) Inventor: Simar Kohli, Syosset, NY (US)

(21) Appl. No.: 15/642,523

(22) Filed: Jul. 6, 2017

(51) Int. Cl. B01D 15/36

(52) U.S. Cl. CPC B01D 15/361; B01D 39/04

(57) ABSTRACT

The present invention pertains to the use of cob of Zea Mays as an ion exchange filter to remove heavy metal impurities from water, for human consumption. The present invention also relates to the chemical methods and processes that enable cob of Zea Mays to act as an ion exchange filter. In preferred embodiments, the organometallic cellulose is derived from any plant material that comprises of cellulose.

### TECHNICAL FIELD OF DISCLOSURE

This invention relates to low-cost water purification methods. More specifically, the invention is related to chemical methods and processes to remove heavy metal impurities like Cu, Pb, and As dissolved in water, by utilizing readily available plant material, like the cob of Zeya Mays. Treated water would then be more suitable for human consumption.

### BACKGROUND OF DISCLOSURE

Clean drinking water is a basic requirement for healthy human development and life. In 2015, 663 million people still lacked improved drinking water. In rural areas, eight out of ten people access to clean water sources. Even when a water supply is available, the removal of dissolved heavy metal impurities is always a challenge. Utilizing coagulation, sedimentation, filtration and disinfection, water treatment plants remove only about 50% of drugs and other contaminants from drinking water [1]. However, even when potable water is provided by water authorities, an estimated 98% of American houses built after the 1970s have copper pipes, which may corrode and leach the metal into drinking water. This excess consumption of copper has been seen to contribute to Alzheimer's disease, arteriosclerosis, and diabetes mellitus. For example, trace amounts of copper in drinking water—less than one-tenth of that allowed in human drinking water by the Environmental Protection Agency—greatly enhanced a neurodegenerative disease in an animal model [2].

Filters that utilize activated carbon, or reverse osmosis may be used to remove copper from water. Reverse osmosis, ion exchange, and activated carbon systems cost between $50 and $500 for the filter mechanism, and annual filter replacements range from $100 to $200. Unfortunately, these filtration costs may be prohibitive for those living in developing countries. In a recent study, an estimated 44.5 percent of children live on less than $3.10 per day, as opposed to 26.6 percent of adults [3]. Therefore, an inexpensive copper filtration system is needed to allow impoverished families access to clean, drinkable water.

Zea Mays cob can be chemically modified to produce various compounds including food stabilizer & thickeners, reinforced polymers, lignin droplets and soluble starch [4]-[6]. The absorbent properties of light weight granular properties have been used as filler for absorbent pillow [7].

Water filtration properties of Zea Mays cob have been compared recently. Phosphoric acid activated Zea Mays cob was not only able to reduce the acidity of the treated water samples but also able to remove chlorides. The activated Zea Mays cob was also reported to be more efficient in turbidity and ammonia nitrogen removal [8]. However, to the best of knowledge the ion-exchange properties of Zea Mays cob for removal of dissolved heavy metals impurities like copper have not been studied in the prior arts.

### SUMMARY OF THE DISCLOSURE

Various embodiments of the disclosure provide a method to use cellulose from plant material-like the cob of Zeya Mays as a heavy metal ion exchange filter to remove dissolved heavy metal impurities from water. Embodiments of the current invention enable utilization of a common plant waste product to be utilized as a cost-effective ion-exchange water filter. The filtration process under the present disclosure would render the unfiltered water-unsuitable for human consumption-filtered. Under the present disclosures, Zea mays cob discs were microwave irradiated, treated with an alkaline base solution and acidic solution to produce water insoluble organometallic cellulose, capable of exchanging and trapping the heavy-metal ions within the solution. Percolating ability of heavy metal impurities through this organometallic cellulose was identified using optical absorption spectroscopy. Ion exchange between alkali metal based cellulose and copper ions is explained at molecular level.

Other features and advantages are described and more readily apparent from a review of the detailed description which follows.

### BRIEF DESCRIPTION OF DRAWINGS

Illustrations listed below are provided to aid the better understanding of the invention outlined in the previous and succeeding sections of this article. It must, however, be noted that these are only typical embodiments of this invention and are therefore not to be considered limiting of its scope.

The patent or application file contains at least one drawing executed in color. Copies of this patent or patent application publication with color drawing(s) will be provided by the Office upon request and payment of the necessary fee.

FIG. 1. Plain view photograph of untreated Zea Mays cobs used in present disclosure

FIG. 2. Plain view photograph of Zea Mays cobs used in present disclosure after treatment with sodium hydroxide (NaOH) and trichloroacetic acid.

FIG. 3. Plain view photograph of Zea Mays cobs used in FIG. 2 after copper (Cu) filtration.

FIG. 4. 2-dimensional (2-D) Crystal structure [9] of untreated cellulose view normal to (001) plane. Carbon and Oxygen are represented by their elemental symbols C and O respectively. Arabic numerals next symbols are used to differentiate atomic positions.

FIG. 5. 2-dimensional (2-D) Crystal structure [9] of sodium hydroxide (NaOH) and trichloroacetic acid treated cellulose view normal to (001) plane. Carbon, Oxygen and Sodium are represented by their elemental symbols C, O and Na respectively. Arabic numerals next symbols are used to differentiate atomic positions.

FIG. 6. 2-dimensional (2-D) Crystal structure [9] of copper chloride treated cellulose used in FIG. 5 view normal to (001) plane. Carbon, Oxygen and Copper are represented by their elemental symbols C, O and Cu respectively. Arabic numerals next symbols are used to differentiate atomic positions.

FIG. 7. Spectral dependence of normalized absorption of 0.1M copper chloride (CuCl) solution

FIG. 8. Relative absorption of CuCl solution before and after filtration

FIG. 9. Cross-section view of low cost water filter comprising homogenous mixture of charcoal and Na activated cob of Zea Mays

FIG. 10. Cross-section view of low cost water filter using an arrangement comprising of individual layers of charcoal and Na activated cob of Zea Mays

FIG. 11. Cross-section view of low cost water filter using an arrangement comprising of multiple alternating layers of charcoal and Na activated cob of Zea Mays.

FIG. 12. Cross-section view of low cost water filter using only cob of Zea Mays.

### DESCRIPTION

The present invention relates to the use of cob of plant Zea Mays as an organic ion-exchange filter for the removal of heavy metal impurities like (but not limited to) copper (Cu), Lead (Pb), Arsenic (As).

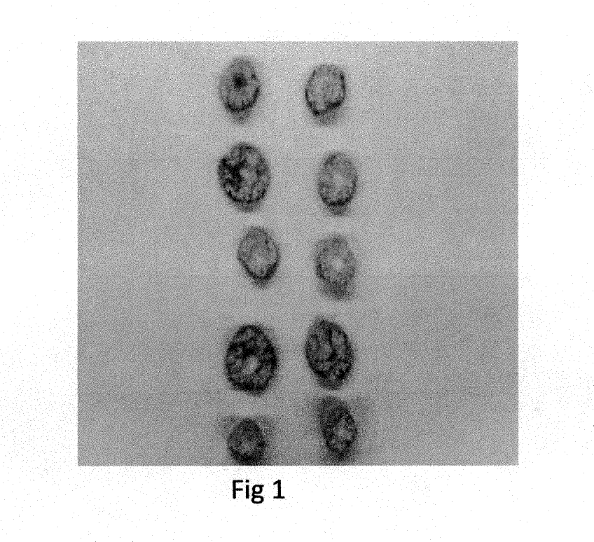

According to the first aspect of the present invention cob of plant Zeya Mays is used. Zeya Mays cob comprises of approximately 39% cellulose, 42% hemicellulose, 9% lignin, 2% protein, 1% ash, and 0.67% starches. In another aspect of this invention any organic plant material may be used as a source of cellulose or hemicellulose. FIG. 1, shows the plain-view photograph of untreated cobs of Zeya Mays. As visible to naked eyes, the color of unreacted cob is yellowish-white.

Per the current invention, Zeya Mays cob is exposed to microwave irradiation for between one second to five hundred second—preferably 300 s. This is done to increase the molecular motion of hydroxyl groups within the cellulose and/or hemi-cellulose. However, in another aspect of this invention the energy of the reaction may be provided by thermal (heat), optical (ultra-violet or infra-red light) or any other chemical methods known or unknown at this time.

Per the current invention Zeya Mays cob is reacted with chemical(s) comprising at least one or more sodium (Na) and/or potassium (K) atom bonded to an organic or inorganic compound. The compound of alkaline metal may either be in liquid or gas phase. Preferably the alkaline metal compound may be in a base solution (example hydroxide of sodium) with molarity ranging from 1 molar to 10 molars but preferably 6 molar.

The alkalized cob of Zeya Mays piece is then treated with tricholoroacetic acid to complete etherification. In another aspect of this invention any other acetic acid comprising of at least one halogen element can be used for etherification. Subsequent to treatment the corncob was treated with distilled water to remove excess acid and base thus achieving neutrality of the cob of Zeya Mays on a pH scale (pH=7).

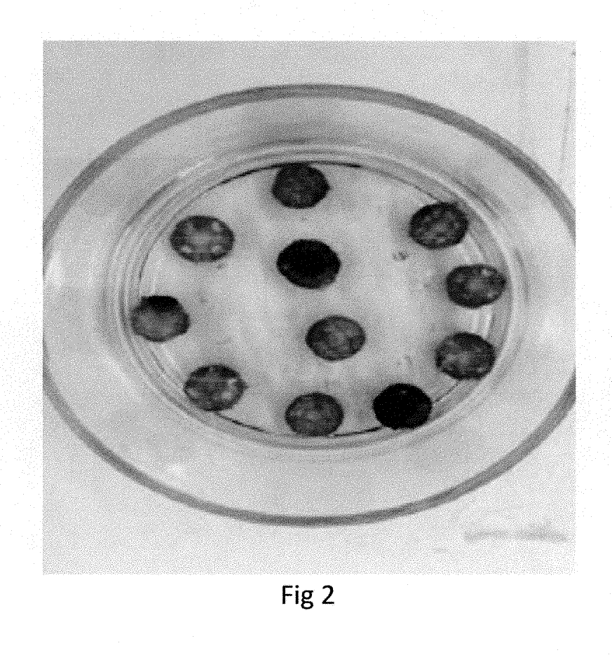

As a result of the reaction between cob of Zeya Mays and chemical solution of Na or K (or both), all or some of the Na atoms replace terminal or non-terminal atoms of cellulose or hemi-cellulose of the plant product. FIG. 2 shows the plain-view photograph of the various cobs of Zeya Mays that had undergone etherification and been treated with distilled water. Clearly, change in the color of treated cob is visible to naked eye. As visible to naked eyes, the color of reacted cob after etherification has turned to golden-dark brownish. It must be noted that after completion of etherification, the alkali metal based organometallic cellulose formed is insoluble in water.

According to the current invention when the chemically treated cob of Zeya Mays comes in contact with water containing dissolved heavy metal impurities like Cu, Pb or As, a mutual ion exchange occurs between some or all of these alkaline ions and heavy metal ions. It is noted that the water in this invention may either exist in liquid or vapor form.

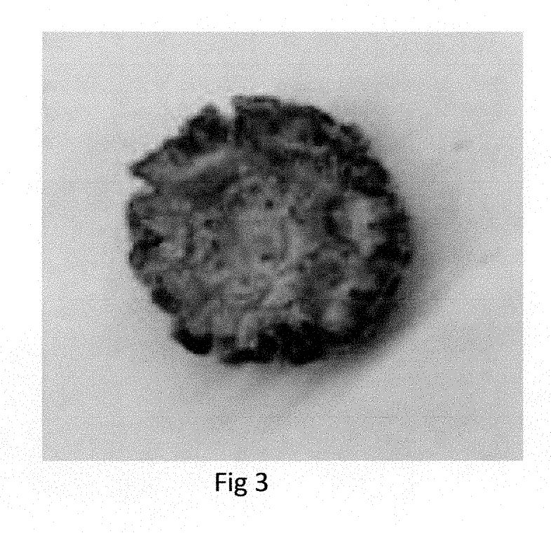

As a result of this mutual ion exchange, some or all of the alkaline ions in the cob of Zeya Mays are replaced with the heavy metal ions in the water. Hence, the treated water now has lower concentration of heavy metals ions as compared to the untreated solution. Meanwhile the treated cob of Zeya Mays now has higher concentration of Cu. Plain-view image of treated Cob after Cu filtration is shown in FIG. 3. Clearly, change in the color of the cob where Na atoms have been successfully replaced by Cu ion is visible to naked eye. As visible to naked eyes, the color of copper treated cob is blueish-green.

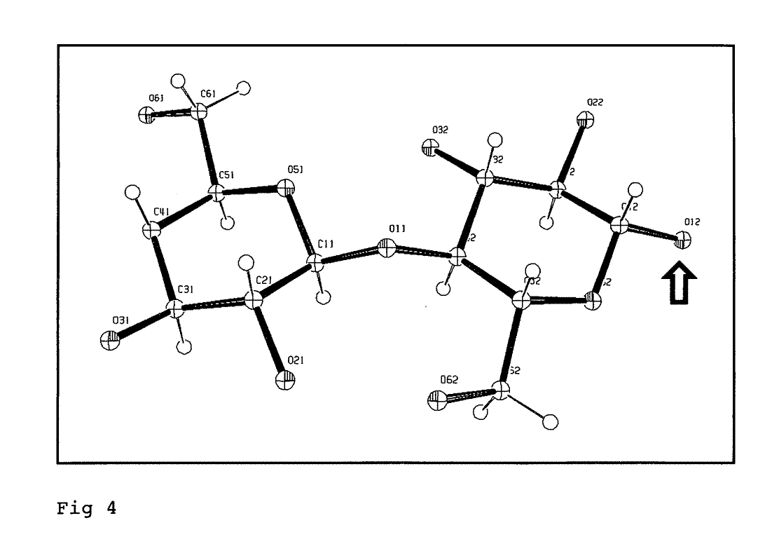

Zeya Mays cob cellulose primarily exists in α-cellulose form (˜47%) with remainder being comprised of β-(25.45%), γ-cellulose (27.27%) [10]. This ion exchange occurring at molecular level is shown in FIG. 4-6 [11] [12] for α-cellulose.

FIG. 4 shows the 2-D plot of crystal structure of untreated α-cellulose viewed normal to (001) plane. Different Carbon (C), Hydrogen (H) and Oxygen (O) atoms occupying various crystallographic positions [13] are shown. Carbon and Oxygen atoms are labelled with their elemental symbols, C and O respectively, followed by Arabic numerals to differentiate different positions in the unit cell. Hydrogen atoms are not labelled for the sake of simplicity. Atomic position of an element (in this case O12) where ion exchange occurs due to reaction is marked with an arrow for the sake of aid of viewer only. While ion exchange is being shown to occur at only one atomic site, it must be noted that more than one atom of the structure may participate during this ion exchange process.

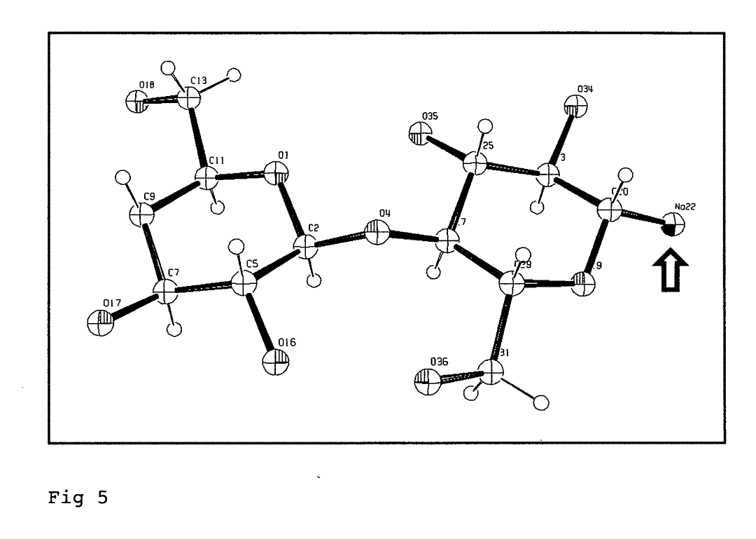

In one aspect of this invention, as a result of treatment with alkaline metal compound, one of the O ion (O12) is replaced by Sodium (Na) ion (Na22). FIG. 5 shows the 2-D plot of crystal structure of α-cellulose viewed normal to (001) plane where one of the O atom (012) has been replaced by Na atom (Na22). The replaced O atom is shown here at end of chain (FIG. 5). In yet another aspect of this invention, the replaced atoms may also be a part of ring or chain structure. Replaced atom may either be single or multiple.

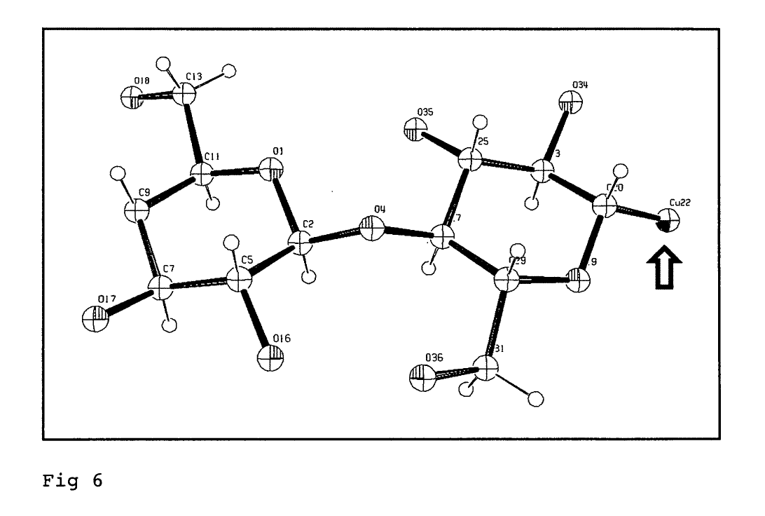

After, alkaline metal treated cellulose (FIG. 5) is exposed to aqueous solution containing copper (Cu) ion exchange occurs between Na and Cu ions. This leads to Cu in solution replacing Na in cellulose and vice versa. Post this ion exchange, Cu is bonded to cellulose structure and immobilized. This leads to removal of Cu from the water. FIG. 6 shows the 2-D plot of crystal structure of α-cellulose viewed normal to (001) plane where one of the Na atom (Na22) in FIG. 5 has now been replaced by Cu atom (Cu22).

In another aspect of this invention, Na can replace elements other than O subsequently be replaced by copper.

In another aspect of this invention, Na can weakly bond to any of the atoms of cellulose and subsequently be replaced by copper

The ion exchange process described in this invention is not only limited to the “α” phase of cellulose. It is appreciated that this ion exchange process may occur with other crystallographic (example (β, γ-cellulose), amorphous, microcrystalline or nanocrystalline phases of cellulose.

The ion exchange between Na and Cu may occur by methods other than outlined in any of the preceding steps.

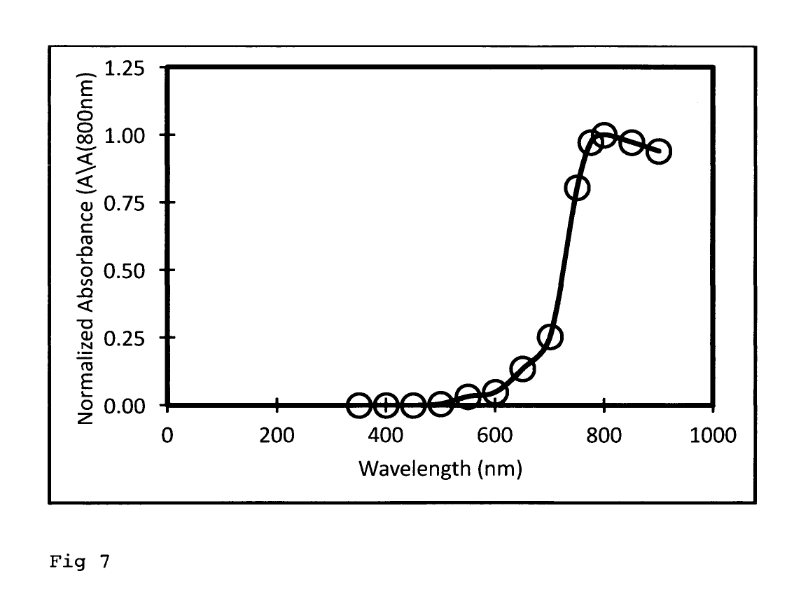

FIG. 7 shows the normalized optical spectra of the control sample containing Cu.

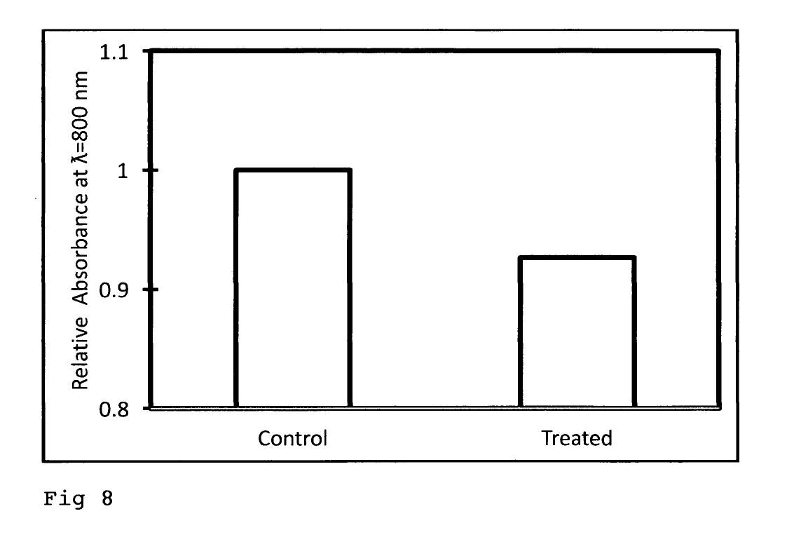

FIG. 8 shows the reduction in absorption of the control sample after being treated with one cob discs (diameter 20 mm×thickness 2 mm). The reduced absorption (more transmitting control sample) is an indicative of removal of Cu from the control solution. In yet another aspect of this invention, multiple cob discs of different diameter and thickness or granular treated cob is used leading to >2× (preferably >10×) reduction of absorption of control solution.

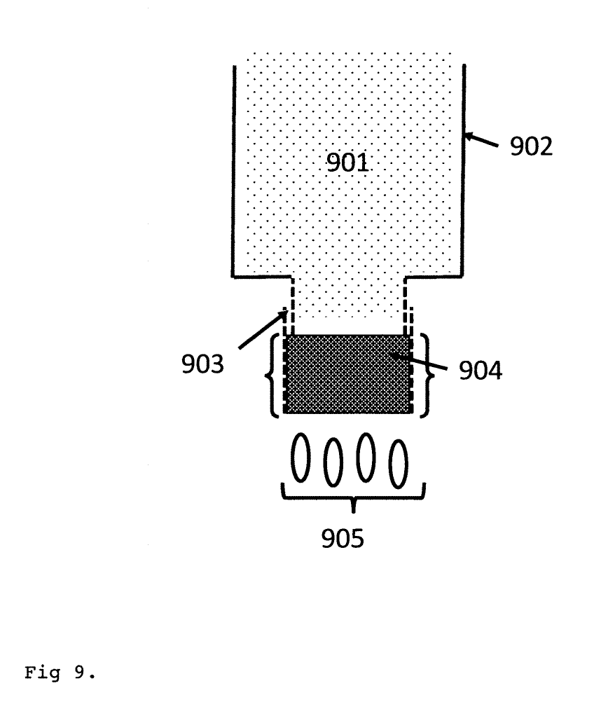

FIG. 9 shows the examples of cross-section view of the arrangement of Na activated cob of Zeya Mays and charcoal for low cost water filtration system. In this arrangement, unfiltered water (901); not suitable for human consumption; is contained in a vessel (902) that is enclosed from at least two sides. Removable filter (903) comprising of a mixture of charcoal and Na activated cob of Zeya Mays (904) enables the filtration of unfiltered water (901) when the unfiltered water passes through element (904); thus, yielding filtered water (905) suitable for human consumption.

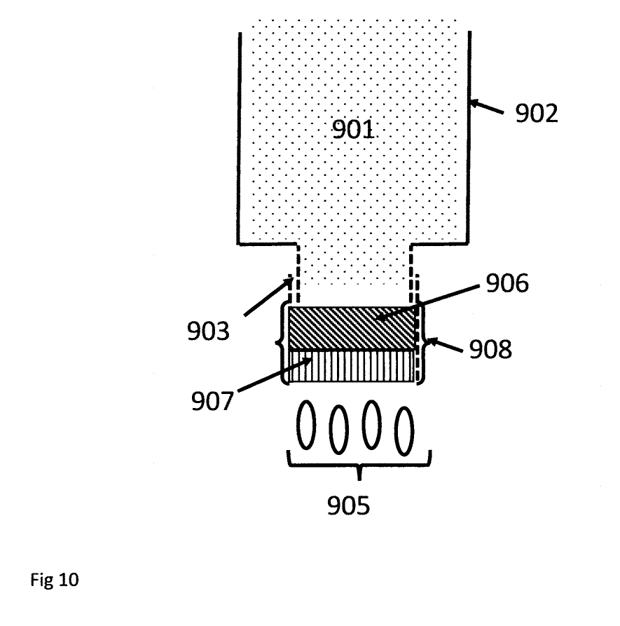

Some of the other arrangements of the filtration media are shown in FIGS. 10-13.

FIG. 10 shows the arrangement of (903) where the filtration media (908) is bi-layer stack of a separate layer of charcoal (906) and Na activated cob of Zeya Mays (907). Placement of the layer of charcoal and activated cob with respect to the flow of unfiltered water is not important for the limitation of this invention.

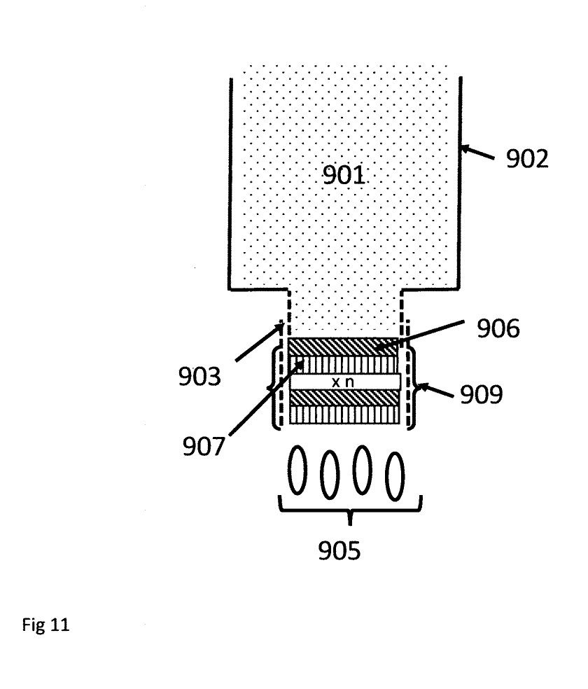

FIG. 11 shows the arrangement of (903) where the filtration media (909) is repeating layers of bi-layers of a separate layer of charcoal (906) and Na activated cob of Zeya Mays (907). According to this arrangement, the bi-layer stacks may be repeated at at-least two times (n>=2). Placement of the layer of charcoal and activated cob with respect to the flow of unfiltered water is not important for the limitation of this invention.

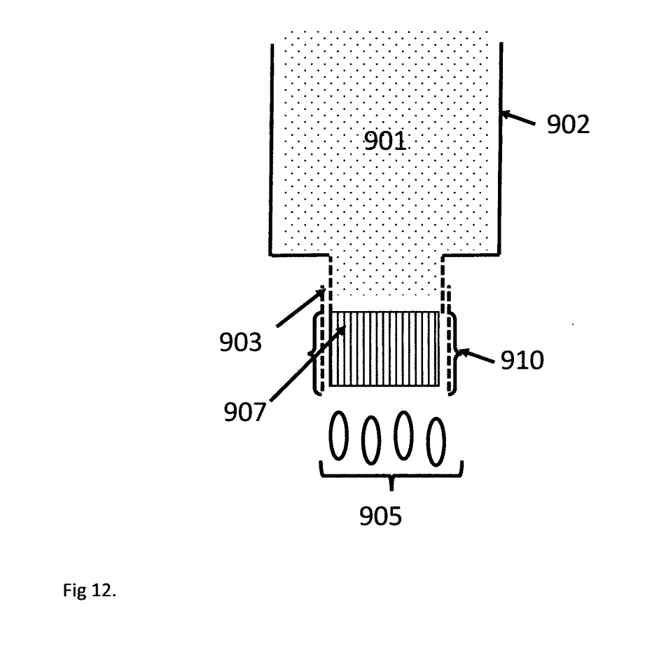

FIG. 12 shows the arrangement of (903) where the filtration media (909) is only comprised of Na activated cob of Zeya Mays (907).

In the spirit of this work, these are not the only way Na activated cob of Zeya Mays may be used.

After at least one cycle of water purification (preferably >1000), a new filtration element (903) comprised of chemically treated cob of Zeya Mays may be used.

From the forgoing description, it is clear that the disclosed embodiments provide an effective and low cost method for removing the heavy metal impurities from potable water utilizing plant cellulose (Zeya Mays).

In another aspect of this invention cob of Zeya Mays may be grounded to particles >1 mm to increase the surface area of reaction.

In another variation of this invention source of cellulose or cellulose may be any other plant or plant product.

All of the features disclosed in this specification (including any accompanying claims, abstract and drawings), and/or all of the steps of any method or process so disclosed, can be combined in any combination, except combinations where at least some of such features and/or steps are mutually exclusive. Each feature disclosed in this specification can be replaced by alternative features serving the same, equivalent, or similar purpose, unless expressly stated otherwise. Thus, unless expressly stated otherwise, each feature disclosed is one example only of a generic series of equivalent or similar features.

For purposes of interpreting the claims for the present invention, it is expressly intended that the provisions of Section 112, sixth paragraph of 35 U.S.C. are not to be invoked unless the specific terms “means for” or “step for” are recited in the subject claim.

### BIBLIOGRAPHY

[1] S. T. Glassmeyer et al., “Chemical and microbial contaminants of emerging concern in source and treated drinking water,” in ABSTRACTS OF PAPERS OF THE AMERICAN CHEMICAL SOCIETY, 2013, vol. 246.
[2] G. J. Brewer, “Risks of Copper and Iron Toxicity during Aging in Humans,” Chem. Res. Toxicol., vol. 23, no. 2, pp. 319-326, 2010.
[3] D. L. Newhouse, P. Suarez-Becerra, and M. Evans, “New estimates of extreme poverty for children,” 2016.
[4] M. Li, Y.-L. Cheng, N. Fu, D. Li, B. Adhikari, and X. D. Chen, “Isolation and characterization of corncob cellulose fibers using microwave-assisted chemical treatments,” Int. J. Food Eng., vol. 10, no. 3, pp. 427-436, 2014.
[5] J.-A. Han and S.-T. Lim, “Structural changes of corn starches by heating and stirring in DMSO measured by SEC-MALLS-RI system,” Carbohydr. Polym., vol. 55, no. 3, pp. 265-272, 2004.
[6] T.-S. Sun, K. Wang, G. Yang, H.-Y. Yang, and F. Xu, “Hydrothermal treatment and enzymatic saccharification of corncobs,” BioResources, vol. 9, no. 2, pp. 3000-3013, 2014.
[7] A. R. Cowling, “Absorbent pillow,” U.S. Pat. No. 4,497,712, February-1985.
[8] D. Adie, S. Lukman, B. Saulawa, and I. Yahaya, “Comparative Analysis of Filtration Using Corn Cob, Bone Char and Wood Chippings,” Int. J. Appl., vol. 3, no. 3, 2013.
[9] L. W. Finger, M. Kroeker, and B. H. Toby, “it DRAWxtl, an open-source computer program to produce crystal structure drawings,” J. Appl. Crystallogr., vol. 40, no. 1, pp. 188-192, February 2007.
[10] S. Kumar, Y. S. Negi, and J. S. Upadhyaya, “Studies on characterization of corn cob based nanoparticles,” Adv Mater Lett, vol. 1, no. 3, pp. 246-253, 2010.
[11] R. M. Hanson, J. Prilusky, Z. Renjian, T. Nakane, and J. L. Sussman, “JSmol and the Next-Generation Web-Based Representation of 3D Molecular Structure as Applied to Proteopedia,” Isr. J. Chem., vol. 53, no. 3-4, pp. 207-216, 2013.
[12] L. J. Farrugia, “it WinGX and it ORTEP for Windows: an update,” J. Appl. Crystallogr., vol. 45, no. 4, pp. 849-854, August 2012.
[13] Y. Nishiyama, J. Sugiyama, H. Chanzy, and P. Langan, “Crystal Structure and Hydrogen Bonding System in Cellulose Iα from Synchrotron X-ray and Neutron Fiber Diffraction,” J. Am. Chem. Soc., vol. 125, no. 47, pp. 14300-14306, 2003.

What is claimed here is:

1. A method of filtration of heavy metal impurities from potable water wherein:
activated cellulose of the cob of Zeya Mays is used as ion exchange heavy metal filter
activated cellulose from other plant based organic materials may also be used for the claimed purposes.
Method of claim 1 where the cob of Zeya Mays has been previously treated with alkaline metal compound and tri-chloro-acetic acid.
Method of claim 1 where the chemically treated cob of Zeya Mays is neutral on pH scale (pH=7)
Method of claim 1 where the pH neutral, chemically treated cob of Zeya Mays has least one alkaline ion which is bonded to the at least one terminal or non-terminal atom of the cellulose or hemi-cellulose of the cob.
Method of claim 1 where when the chemical treated cob as in [14-30] comes in contact with water containing heavy impurities; an ion exchange occurs between at least one atom of alkaline material of the cob and heavy metal ions like copper dissolved in water.
As a result of this ion exchange, the water now has lower concentration of heavy metal ions than prior to filtration.
Method of claim 1, wherein after the filtration is completed, the heavy metal ions are now immobile and bonded to the cellulose or hemi-cellulose of the cob.
Method of claim 1, wherein the heavy metal filtration can be repeated using the same cob for at least one time.
